(19) United States
(12) Patent Application Publication
(10) Pub. No.: US 2019/0040938 A1
(43) Pub. Date: Feb. 7, 2019

(54) ELECTRONIC DEVICE

(71) Applicant: Lite-On Technology Corporation, Taipei (TW)

(72) Inventor: Hung-Chang Chien, Taipei (TW)

(73) Assignee: Lite-On Technology Corporation, Taipei (TW)

(21) Appl. No.: 16/034,372

(22) Filed: Jul. 13, 2018

Related U.S. Application Data
(60) Provisional application No. 62/540,586, filed on Aug. 3, 2017.

(30) Foreign Application Priority Data
May 3, 2018 (CN) 201810413722.8

(51) Int. Cl. F16H 19/04; F16H 19/08

(52) U.S. Cl. CPC F16H 19/04; F16H 19/08

(57) ABSTRACT

An electronic device includes a motor, a gear set, a meter frame set, a first screw rod, and a second gear rack. The gear set is driven by the motor and includes a first gear. The meter frame set includes a first gear rack extending along an arc line and adapted to be engaged with the first gear of the gear set. When the motor is operated and the first gear rack is engaged with the first gear, the first gear drives the first gear rack such that the meter frame set moves along the arc line. The first screw rod is linked with the gear set and extends along a first axis. The second gear rack is adapted to be linked with the meter frame set. When the motor is operated and the second gear rack is engaged with the first screw rod, the first gear rack is not engaged with the first gear, and the meter frame set is linked with the second gear rack to move along the first axis with the second gear rack.

### CROSS-REFERENCE TO RELATED APPLICATION

This application claims the priority benefit of U.S. provisional application Ser. No. 62/540,586, filed on Aug. 3, 2017. and China application serial no. 201810413722.8, filed on May 3, 2018. The entirety of each of the above-mentioned patent applications is hereby incorporated by reference herein and made a part of this specification.

### BACKGROUND OF THE INVENTION

### Field of the Invention

The disclosure relates to an electronic device, and in particular, to an electronic device in which a meter frame set is movable.

### Description of Related Art

Currently, digital meters have gradually been adopted as vehicle meters. Namely, LED display screens are used to display information. Although the digital meter displays in multiple colors, it displays with a flat panel and a user may need to adjust the seat height or posture before he or she can see the information displayed on the digital meter. If the position of the digital meter can be adjusted according to the user's requirement, it will be more convenient in use.

### SUMMARY OF THE INVENTION

The embodiments of the invention provide an electronic device including a meter frame set that is movable.

An electronic device according to an embodiment of the invention includes a motor, a gear set, a meter frame set, a first screw rod, and a second gear rack. The gear set is driven by the motor and includes a first gear. The meter frame set includes a first gear rack extending along an arc line. The first gear rack is adapted to be engaged with the first gear of the gear set. When the motor is operated and the first gear rack is engaged with the first gear, the first gear drives the first gear rack such that the meter frame set moves along the arc line. The first screw rod is linked with the gear set and extends along a first axis. The second gear rack is adapted to be linked with the meter frame set. When the motor is operated and the second gear rack is engaged with the first screw rod, the first gear rack is not engaged with the first gear, the meter frame set is linked with the second gear rack to move along the first axis with the second gear rack.

In an embodiment of the invention, the electronic device further includes a moving lever including a first bump. The gear set includes a second gear engaged with the first gear. The second gear includes a first track recessed in one surface of the second gear. The first bump reaches into the first track. The first track includes a first portion and a second portion. A first end of the first portion is connected to the second portion. A distance between a second end of the first portion and a gear center of the second gear is greater than a distance between the first end of the first portion and the gear center of the second gear. The second portion is in an arc shape.

In an embodiment of the invention, the moving lever further includes a second bump. The meter frame set includes an arc-shaped member. The first gear rack is formed on the arc-shaped member. The arc-shaped member includes a second track recessed in one surface of the arc-shaped member. The second bump reaches into the second track. The second track includes a third portion and a fourth portion extending in different directions. A third end of the third portion is connected to the fourth portion.

In an embodiment of the invention, when the meter frame set is located at a first position, the first gear of the gear set is located by the first gear rack and is not engaged with the first gear rack, the first bump is located at the second end of the first portion of the first track, and the second bump is located at the fourth end of the third portion of the second track. When the second gear rotates such that the first bump of the moving lever moves to the first end of the first portion and the second bump of the moving lever correspondingly moves to the third end of the third portion, the first gear rack is pulled to the first gear, and the first gear rack is engaged with the first gear, such that the meter frame set moves from the first position to a second position.

In an embodiment of the invention, the fourth portion of the second track extends along the arc line to an end of the arc-shaped member. When the meter frame set moves from the second position to a third position, the first bump of the moving lever moves along the second portion of the first track, and the second bump of the moving lever moves along the fourth portion of the second track and slides out of the arc-shaped member.

In an embodiment of the invention, the electronic device further includes a moving bracket set including a first through-hole. A shape of the first through-hole is identical to a shape of the third portion of the second track. The second bump of the moving lever penetrates through the first through-hole and then reaches into the second track. When the meter frame set moves between the first position and the second position, the meter frame set is linked with the moving bracket set.

In an embodiment of the invention, the electronic device further includes a fixed horizontal shaft extending along the first axis. The moving bracket set includes a second through-hole extending along a second axis. The fixed horizontal shaft penetrates through the second through-hole. When the meter frame set moves between the first position and the second position, the meter frame set moves along the second axis with the moving bracket set.

In an embodiment of the invention, the second gear rack is disposed on the moving bracket set. When the meter frame set is located at the first position, the second gear rack is engaged with the first screw rod. When the meter frame set is located at the second position, the second gear rack is not engaged with the first screw rod.

In an embodiment of the invention, the electronic device further includes a second screw rod linked with the motor. The gear set further includes a second gear, a third gear, a fourth gear, and a fifth gear. The third gear is coaxial with and fixed to the fourth gear. The fifth gear is coaxial with and fixed to the first gear. The second screw rod is engaged with the third gear. The fourth gear is engaged with the second gear. The second gear is engaged with the fifth gear.

In an embodiment of the invention, the gear set further includes a sixth gear and a seventh gear. The sixth gear is coaxial with and fixed to the third gear. The seventh gear is coaxial with and fixed to the first screw rod. The sixth gear is engaged with the seventh gear.

Accordingly, the meter frame set of the electronic device of one embodiment of the invention is engaged with the first gear through the first gear rack and can move along the arc line. Moreover, the meter frame set is further engaged with the first screw rod through the second gear rack and can move along the first axis with the second gear rack to meet different requirements of use.

To provide a further understanding of the aforementioned and other features and advantages of the disclosure, exemplary embodiments, together with the reference drawings, are described in detail below.

### BRIEF DESCRIPTION OF THE DRAWINGS

FIG. 1 is a front-view schematic diagram illustrating a meter frame set of an electronic device according to an embodiment of the invention when the meter frame set is located at a first position.

FIG. 2 is a front-view schematic diagram illustrating the meter frame set of the electronic device of FIG. 1 when the meter frame set is located at a third position.

FIG. 3 is a front-view schematic diagram illustrating the meter frame set of the electronic device of FIG. 1 when the meter frame set is located at a fourth position.

FIG. 4 is a perspective schematic diagram illustrating the meter frame set of the electronic device of FIG. 1 without showing the housing when the meter frame set is located at the first position.

FIG. 5 is an exploded schematic diagram of FIG. 4.

FIG. 6 and FIG. 7 are respectively schematic diagrams of FIG. 4 from other viewing angles.

FIG. 8A is a partial side-view schematic diagram illustrating the meter frame set of the electronic device of FIG. 1 when the meter frame set is located at the first position.

FIG. 8B and FIG. 8C are respectively partially enlarged diagrams of FIG. 8A.

FIG. 9 is a partial side-view schematic diagram illustrating the meter frame set of the electronic device of FIG. 1 when the meter frame set is located at a second position.

FIG. 10 is a partial side-view schematic diagram illustrating the meter frame set of the electronic device of FIG. 1 when the meter frame set is located at the third position.

FIG. 11 and FIG. 12 are respectively perspective schematic diagrams illustrating the meter frame set of the electronic device of FIG. 1 from different viewing angles without showing the housing when the meter frame set is located at the third position.

FIG. 13 and FIG. 14 are respectively perspective schematic diagrams illustrating the meter frame set of the electronic device of FIG. 1 from different viewing angles without showing the housing when the meter frame set is located at the fourth position.

### DESCRIPTION OF THE EMBODIMENTS

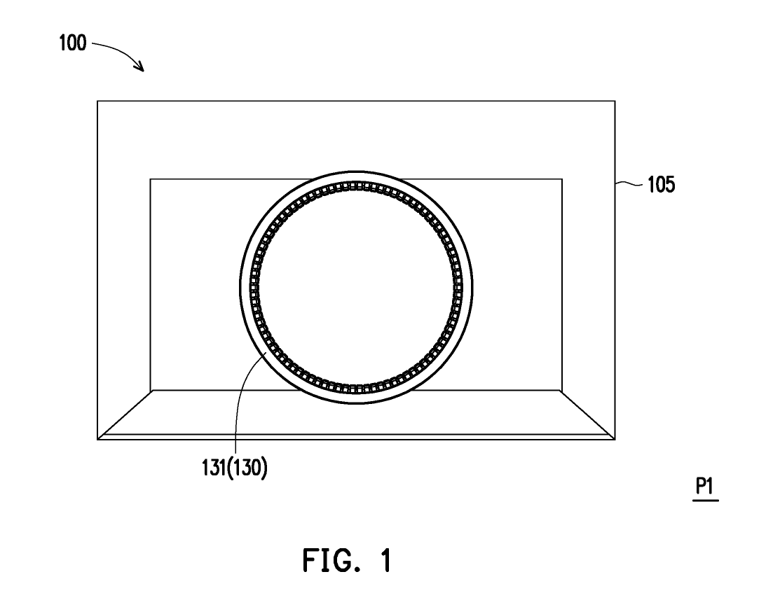

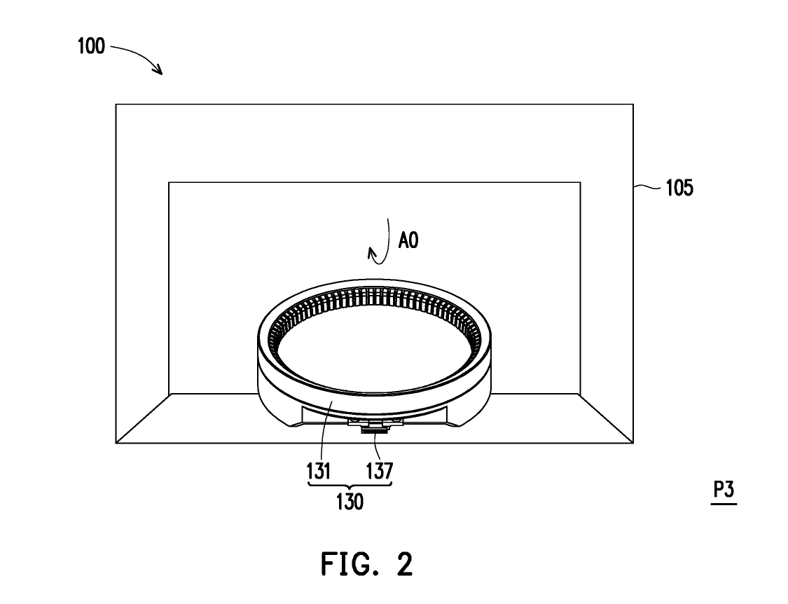

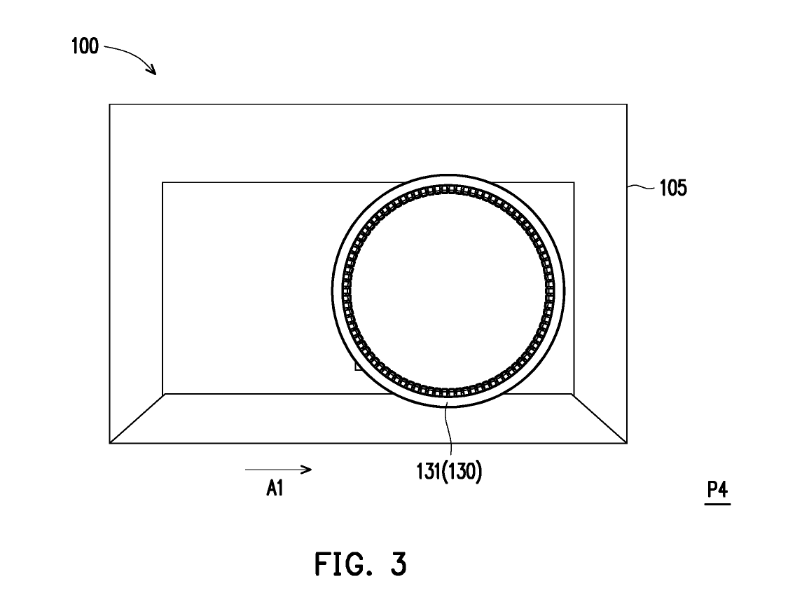

FIG. 1 is a front-view schematic diagram illustrating a meter frame set of an electronic device according to an embodiment of the invention when the meter frame set is located at a first position. FIG. 2 is a front-view schematic diagram illustrating the meter frame set of the electronic device of FIG. 1 when the meter frame set is located at a third position. FIG. 3 is a front-view schematic diagram illustrating the meter frame set of the electronic device of FIG. 1 when the meter frame set is located at a fourth position. Referring to FIG. 1 to FIG. 3, an electronic device 100 of the present embodiment is, for example, a meter device disposed in a vehicle, but the type of the electronic device 100 is not limited hereto. In the present embodiment, the electronic device 100 includes a housing 105 and a meter frame set 130 that is movable with respect to the housing 105. In the present embodiment, as shown in FIG. 1 and FIG. 2, the meter frame set 130 may rotate downward with respect to the housing 105 from a first position P1 to a third position P3. Moreover, as shown in FIG. 1 and FIG. 3, the meter frame set 130 may move rightward with respect to the housing 105 from the first position P1 to a fourth position P4. In other words, the meter frame set 130 of the electronic device 100 of the present embodiment may provide motion in two directions to meet various demands of a user.

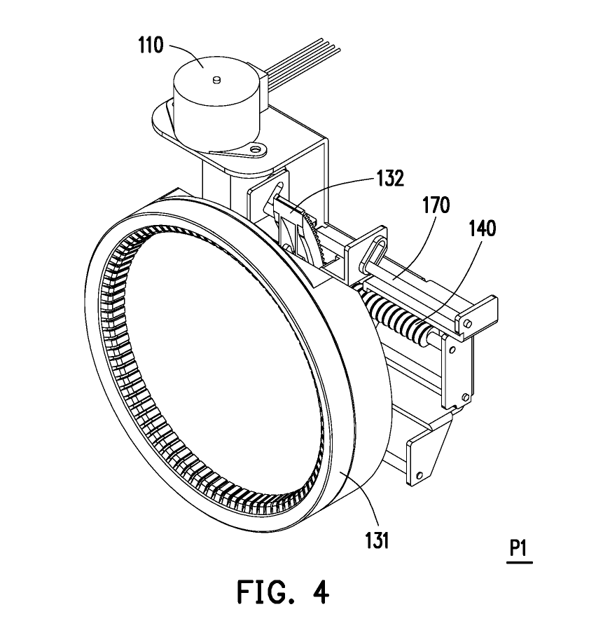

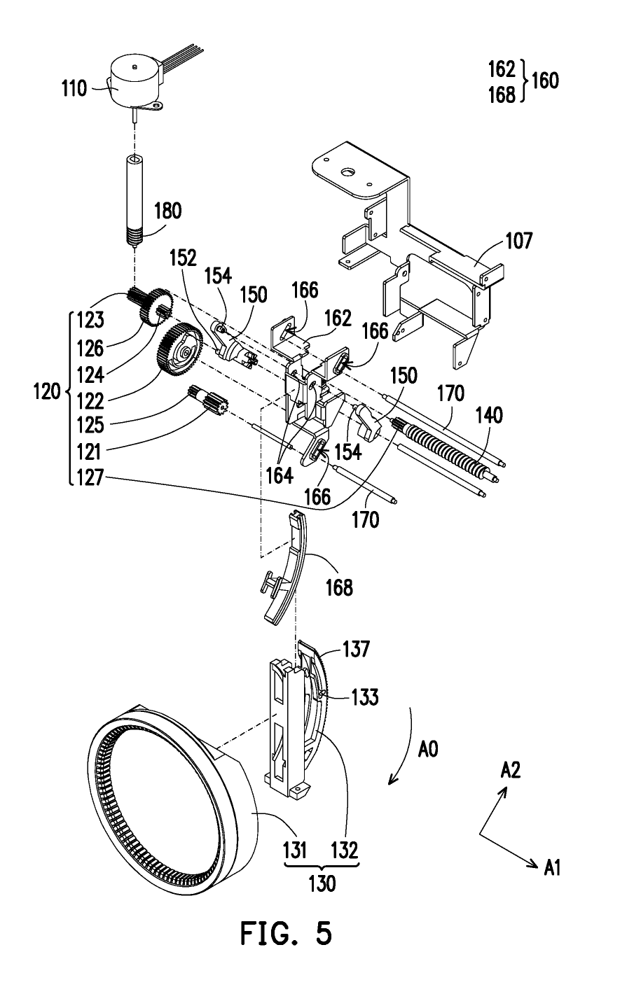

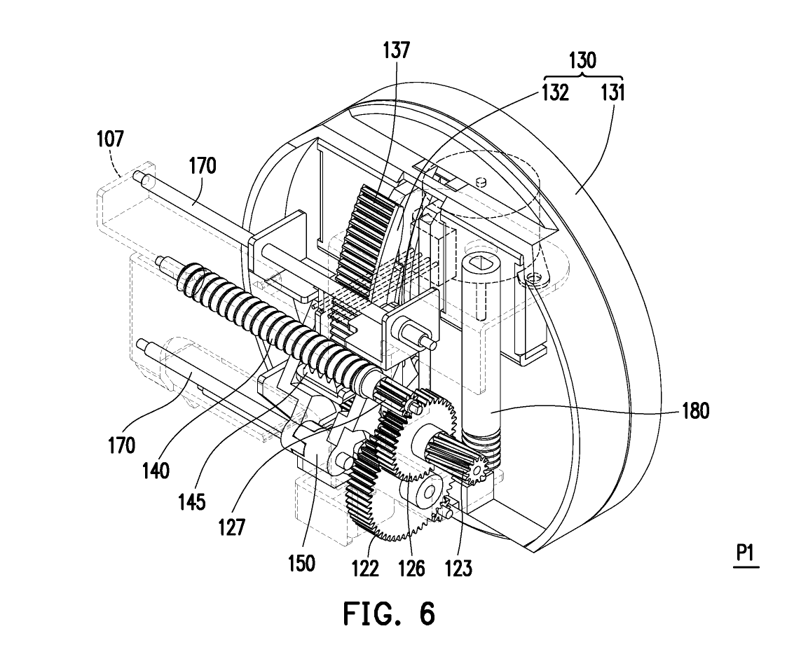

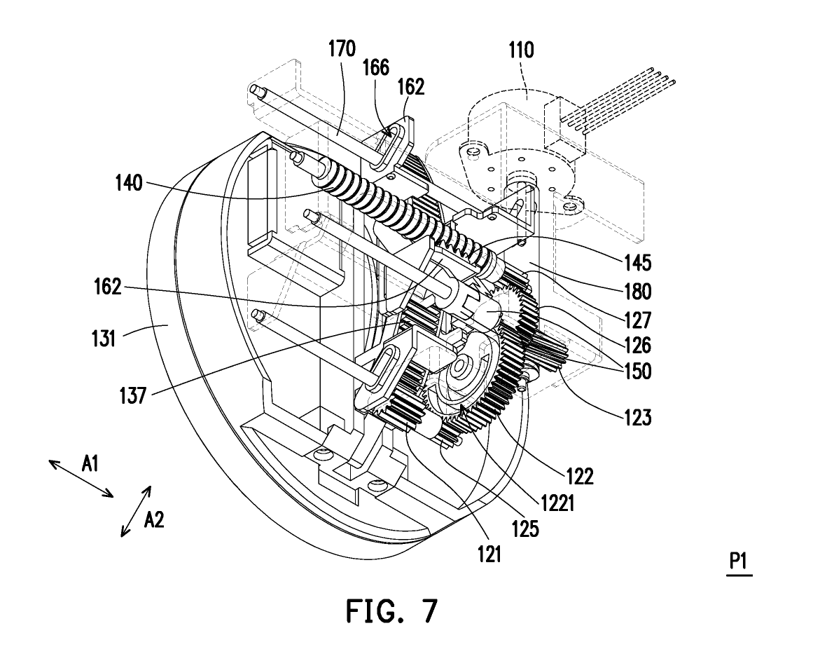

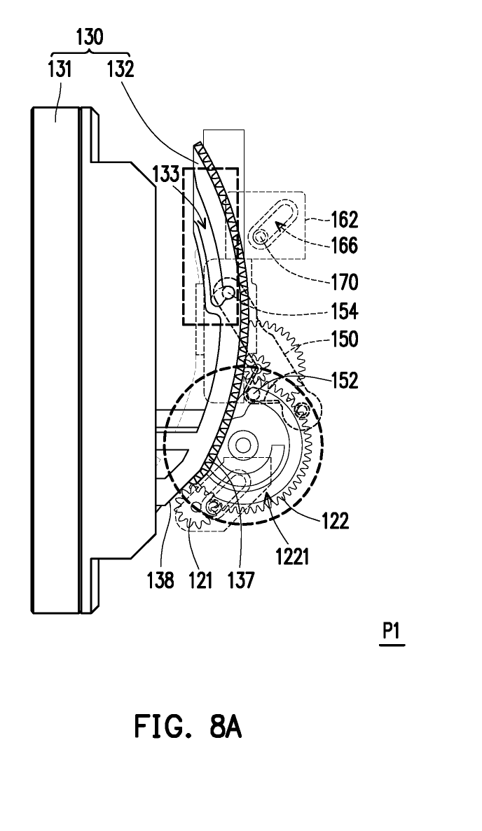

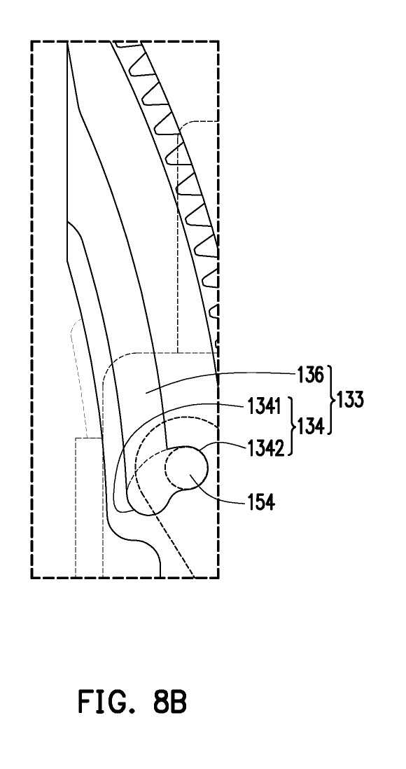

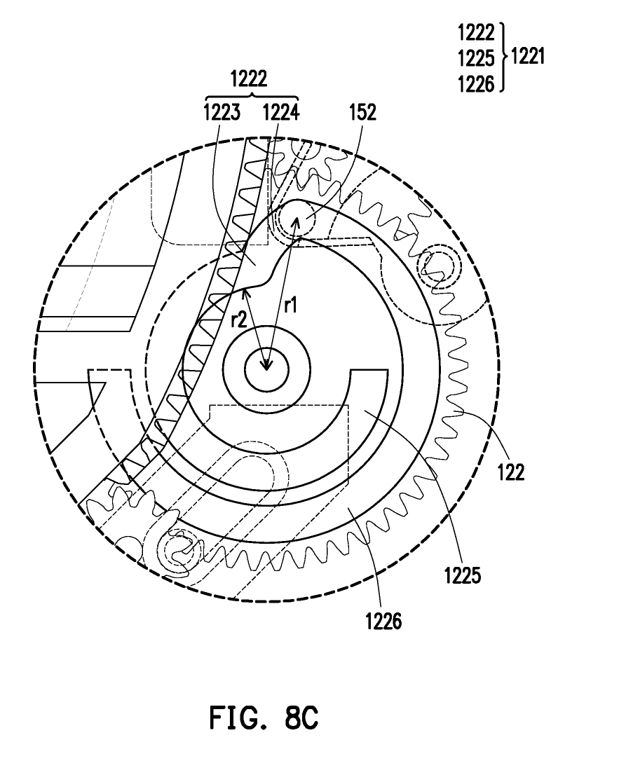

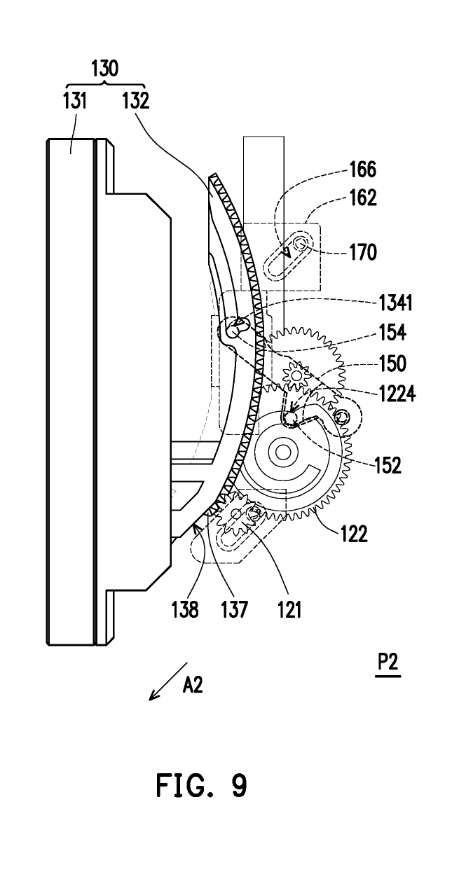

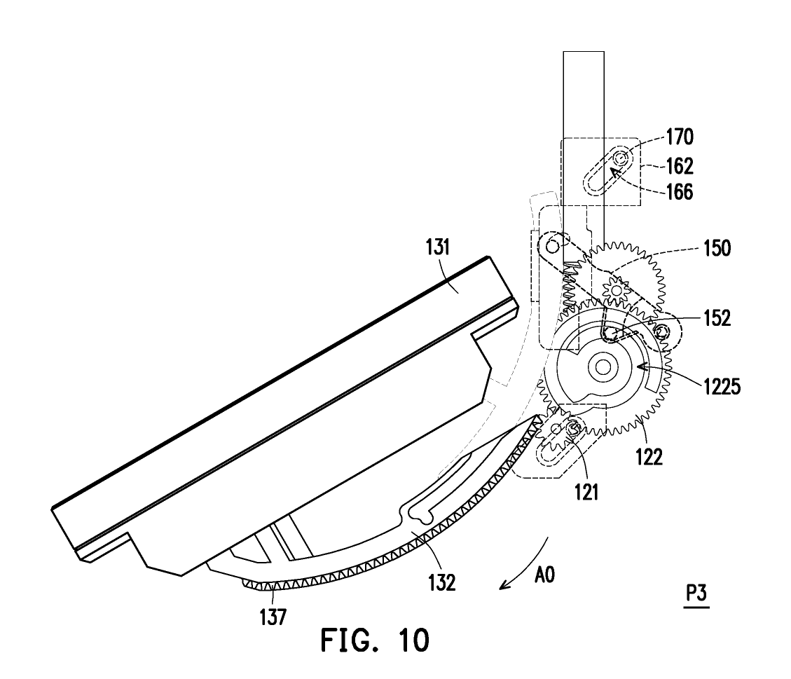

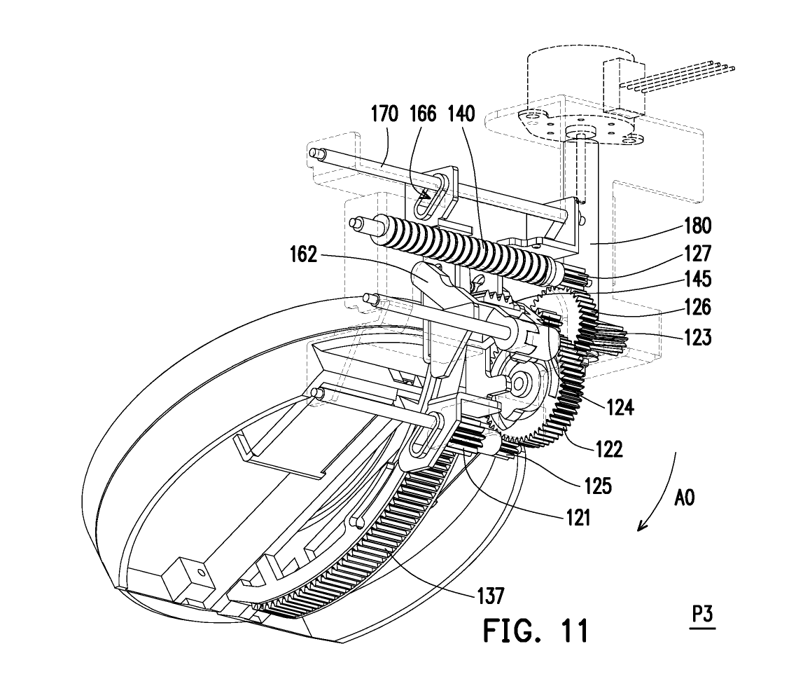

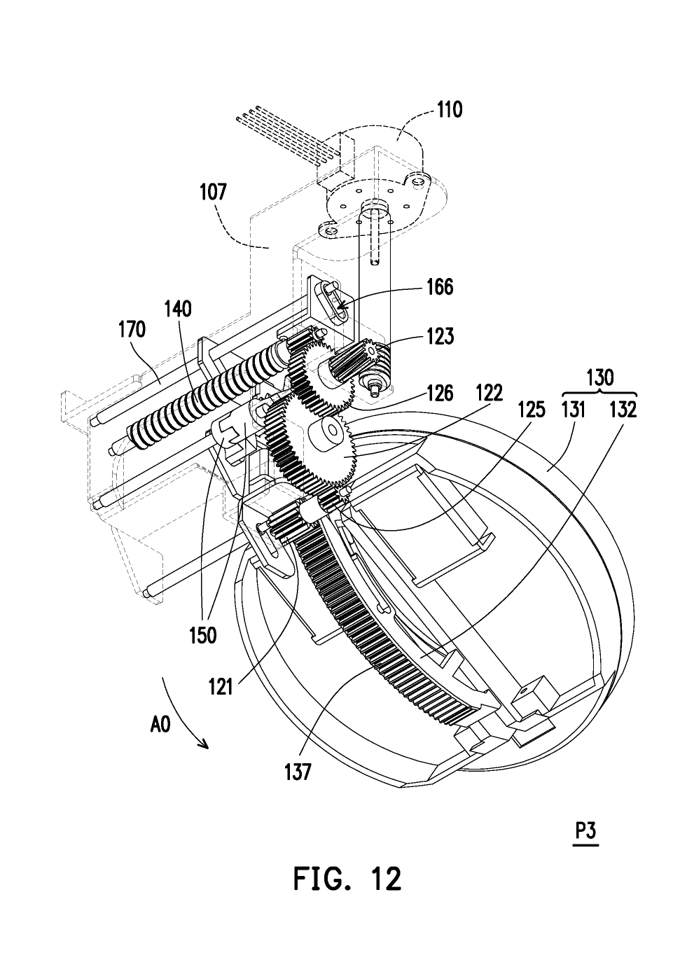

The description below will first illustrate how the internal components of the electronic device 100 enable the meter frame set 130 to rotate downward with respect to the housing 105 from the first position P1 to the third position P3. FIG. 4 is a perspective schematic diagram illustrating the meter frame set of the electronic device of FIG. 1 without showing the housing when the meter frame set is located at the first position. FIG. 5 is an exploded schematic diagram of FIG. 4. FIG. 6 and FIG. 7 are respectively schematic diagrams of FIG. 4 from other viewing angles. FIG. 8A is a partial side-view schematic diagram illustrating the meter frame set of the electronic device of FIG. 1 when the meter frame set is located at the first position. FIG. 8B and FIG. 8C are respectively partially enlarged diagrams of FIG. 8A. FIG. 9 is a partial side-view schematic diagram illustrating the meter frame set of the electronic device of FIG. 1 when the meter frame set is located at a second position. FIG. 10 is a partial side-view schematic diagram illustrating the meter frame set of the electronic device of FIG. 1 when the meter frame set is located at the third position. FIG. 11 and FIG. 12 are respectively perspective schematic diagrams illustrating the meter frame set of the electronic device of FIG. 1 from different viewing angles without showing the housing when the meter frame set is located at the third position. It is noted that some components are rendered in broken lines in some drawings to clearly present the relationships among the components.

Referring to FIG. 4 to FIG. 8A first, an electronic device 100 of the present embodiment includes a motor 110, a second screw rod 180, a gear set 120, a meter frame set 130, a first screw rod 140, and a second gear rack 145. In the present embodiment, the second screw rod 180 is linked with the motor 110 and is engaged with one gear of the gear set 120 such that the gear set 120 is driven by the motor 110. Specifically, in the present embodiment, the gear set 120 includes a first gear 121, a second gear 122, a third gear 123, a fourth gear 124, and a fifth gear 125. As shown in FIG. 5, the third gear 123 is coaxial with and fixed to the fourth gear 124, and the fifth gear 125 is coaxial with and fixed to the first gear 121. In the present embodiment, the second screw rod 180 is engaged with the third gear 123, the fourth gear 124 is engaged with the second gear 122, and the second gear 122 is engaged with the fifth gear 125. As shown in FIG. 5 to FIG. 7, the motor 110 drives the second screw rod 180 to rotate, the second screw rod 180 drives the third gear 123 and the fourth gear 124, the fourth gear 124 drives the second gear 122, and the second gear 122 drives the fifth gear 125 and the first gear 121 to rotate. Therefore, when the motor 110 rotates, the first gear 121 can then rotate. Of course, the gear set 120 may also be in another form, and the number, types, and engagement relationships of the gears of the gear set 120 are not limited hereto.

In the present embodiment, the meter frame set 130 may include a frame 131 and an arc-shaped member 132 disposed on the frame 131. The frame 131 is, for example, a frame 131 of a display panel (not illustrated) of a digital meter. Alternatively, the frame 131 may also be a frame 131 of a pointer meter. A first gear rack 137 extending along an arc line A0 is disposed on the back of the arc-shaped member 132. The first gear rack 137 is adapted to be engaged with the first gear 121 of the gear set 120 such that the meter frame set 130 can rotate downward or upward along the arc line A0. Of course, in other embodiments, the frame 131 and the arc-shaped member 132 may also be one single component, and the form of the meter frame set 130 is not limited hereto.

In the present embodiment, the electronic device 100 may further include at least one moving lever 150. In the present embodiment, the number of the moving lever 150 is two, for example. The two moving levers 150 may be joined together (e.g., at the first position P1 and the third position P3) to move together, and may be separated from each other (e.g., moving from the first position P1 to the fourth position P4). Of course, in other embodiments, the number of the moving lever 150 may also be one, and the number of the moving lever 150 is not limited hereto. As shown in FIG. 5, the moving lever 150 includes a first bump 152 and a second bump 154. In the present embodiment, the first bump 152 and the second bump 154 respectively protrude from two opposite surfaces of the moving lever 150 to reduce a possibility of interference between the mating member (i.e., the second gear 122) of the first bump 152 and the mating member (i.e., the arc-shaped member 132) of the second bump 154. However, the relative positions of the first bump 152 and the second bump 154 are not limited hereto.

As shown in FIG. 8C, the second gear 122 includes a first track 1221 recessed in one surface of the second gear 122. The first bump 152 of the moving lever 150 reaches into the first track 1221 of the second gear 122 and may move along the first track 1221. It is noted that, in FIG. 8C, the first track 1221 is intentionally widened to clearly present different segments of the first track 1221, and the portion blocked by the arc-shaped member 132 from the viewing angle of FIG. 8A is indicated. In the present embodiment, the first track 1221 includes a first portion 1222, a second portion 1225, and a fifth portion 1226. The second portion 1225 is an arc shape having a smaller radius, and the fifth portion 1226 is an arc shape having a larger radius. A first end 1223 of the first portion 1222 is connected to the second portion 1225, and a second end 1224 of the first portion 1222 is connected to the fifth portion 1226. In the present embodiment, a distance r1 between the second end 1224 of the first portion 1222 and a gear center of the second gear 122 is greater than a distance r2 between the first end 1223 of the first portion 1222 and the gear center of the second gear 122.

Moreover, in the present embodiment, the arc-shaped member 132 of the meter frame set 130 includes a second track 133 recessed in one surface of the arc-shaped member 132. In the present embodiment, the second track 133 is located on a side surface of the arc-shaped member 132. The second bump 154 reaches into the second track 133 and may move along the second track 133. As shown in FIG. 8B, the second track 133 includes a third portion 134 and a fourth portion 136 extending in different directions. A third end 1341 of the third portion 134 is connected to the fourth portion 136. The fourth portion 136 of the second track 133 extends to the end of the arc-shaped member 132 along the arc line A0.

As shown in FIG. 8A, in the present embodiment, the first gear rack 137 may include a toothless region 138. When the meter frame set 130 is located at the first position P1, the first gear 121 of the gear set 120 is located in the toothless region 138 and is not engaged with the first gear rack 137. Of course, in other embodiments, it is also possible that the first gear rack 137 does not include the toothless region 138, and the first gear rack 137 is not engaged with the first gear 121 by moving the arc-shaped member 132 of the meter frame set 130 out of the rotation range of the first gear 121.

As shown in FIG. 8A, when the meter frame set 130 is located at the first position P1, since the first gear 121 of the gear set 120 is not engaged with the first gear rack 137, if the meter frame set 130 is to rotate downward, the first gear rack 137 has to be pulled to the first gear 121 first to engage the first gear rack 137 with the first gear 121. Afterwards, rotation of the first gear 121 can then drive the first gear rack 137 to further drive the meter frame set 130 to rotate downward. In the present embodiment, the electronic device 100 completes the foregoing operation through the moving lever 150, the first track 1221 of the second gear 122, and the second track 133 of the arc-shaped member 132.

Specifically, as shown in FIG. 8A, FIG. 8B, and FIG. 8C, when the meter frame set 130 is located at the first position P1, the first bump 152 of the moving lever 150 is located at the second end 1224 of the first portion 1222 of the first track 1221, and the second bump 154 of the moving lever 150 is located at the fourth end 1342 of the third portion 134 of the second track 133. When the motor 110 is operated, the motor 110 drives the second gear 122 to rotate, and the first track 1221 of the second gear 122 moves with respect to the first bump 152, such that the first bump 152 of the moving lever 150 moves to the first end 1223 of the first portion 1222 of the first track 1221, as shown in FIG. 9. In this process, the second bump 154 of the moving lever 150 correspondingly moves to the third end 1341 of the third portion 134 of the second track 133 of the arc-shaped member 134 to pull the first gear rack 137 to the first gear 121. As a result, the first gear rack 137 is engaged with the first gear 121. At this time, the meter frame set 130 moves to a second position P2. Afterwards, the meter frame set 130 can then rotate downward to the third position P3 through coordination between the first gear rack 137 and the first gear 121, as shown in FIG. 10, FIG. 11, and FIG. 12. Of course, in other embodiments, the meter frame set 130 may also move to the third position P3 through components and operations of other types and is not limited hereto.

As shown in FIG. 5, in the present embodiment, the electronic device 100 may further include a moving bracket set 160. The moving bracket set 160 includes a bracket 162 and an arc-shaped track member 168 fixed on the bracket 162. Since the shapes of the bracket 162 and the arc-shaped track member 168 are complex, they may be manufactured separately and then fixed together. Of course, in other embodiments, the bracket 162 and the arc-shaped track member 168 may also be one single component. As shown in FIG. 5, the bracket 162 has a first through-hole 164. In the present embodiment, the shape of the first through-hole 164 is identical to the shape of the third portion 134 of the second track 133. As shown in FIG. 8A and FIG. 8B, from the side viewing angle, the first through-hole 164 and the third portion 134 of the second track 133 overlap with each other. Therefore, in the present embodiment, the second bump 154 of the moving lever 150 penetrates through the first through-hole 164 of the moving bracket set 160 and then reaches into the second track 133. Accordingly, when the meter frame set 130 moves between the first position P1 and the second position P2, the moving bracket set 160 is linked with the meter frame set 130.

As shown in FIG. 9 and FIG. 10, when the meter frame set 130 moves from the second position P2 to the third position P3, the first bump 152 of the moving lever 150 moves along the second portion 1225 of the first track 1221, and the second bump 154 of the moving lever 150 already moves to the fourth portion 136 of the second track 133 although the second bump 154 is still located in the first through-hole 164 of the moving bracket set 160. At this time, the moving bracket set 160 is not linked with the meter frame set 130 anymore, and the meter frame set 130 rotates downward with respect to the moving bracket set 160, such that the second bump 154 of the moving lever 150 slides out of the arc-shaped member 132.

It is noted that, in the present embodiment, the electronic device 100 may further include an inner frame 107 fixed in the housing 105 (labeled in FIG. 1) and a fixed horizontal shaft 170 fixed on the inner frame 107. The fixed horizontal shaft 170 extends along a first axis A1. In the present embodiment, the bracket 162 of the moving bracket set 160 may further have a second through-hole 166 extending along a second axis A2, and the fixed horizontal shaft 170 penetrates through the second through-hole 166. Since the fixed horizontal shaft 170 does not move with respect to the housing 105, the bracket 162 of the moving bracket set 160 may move with respect to the fixed horizontal shaft 170 along the second axis A2. Moreover, the distance range in which the bracket 162 of the moving bracket set 160 moves with respect to the fixed horizontal shaft 170 is close to the length of the second through-hole 166. Referring back to FIG. 8A and FIG. 9, in the present embodiment, when the meter frame set 130 moves between the first position P1 and the second position P2, the meter frame set 130 moves with the moving bracket set 160. As the moving bracket set 160 moves with respect to the fixed horizontal shaft 170 along the second axis A2 (moving toward the lower-left side, for example), the meter frame set 130 moves along the second axis A2 with the moving bracket set 160.

In other words, in the present embodiment, in the process of moving from the first position P1 to the third position P3, the meter frame set 130 first moves to the second position P2 along the second axis A2 (moving toward the lower-left side of FIG. 8A, for example), and then rotates from the second position P2 to the third position P3 along the arc line A0. With this motion mode of first translating toward the obliquely lower side and then rotating downward, a rear space required for rotating the meter frame set 130 downward is reduced. Accordingly, the meter frame set 130 is less likely to interfere with the structure behind it, and arrangement freedom for the rear space of the meter frame set 130 is enhanced. Of course, in other embodiments, the motion mode for the meter frame set 130 to move from the first position P1 to the third position P3 is not limited hereto.

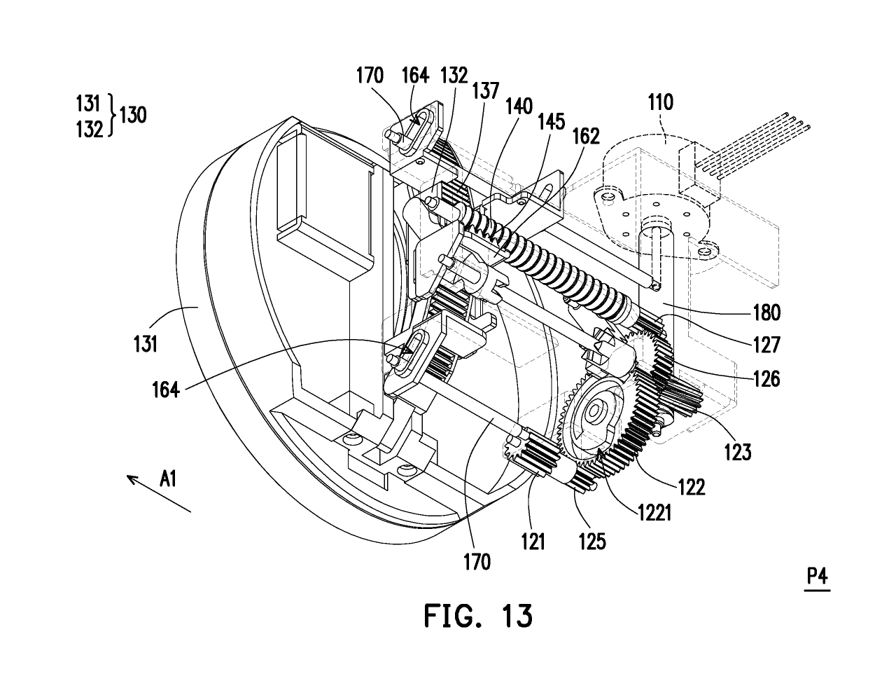

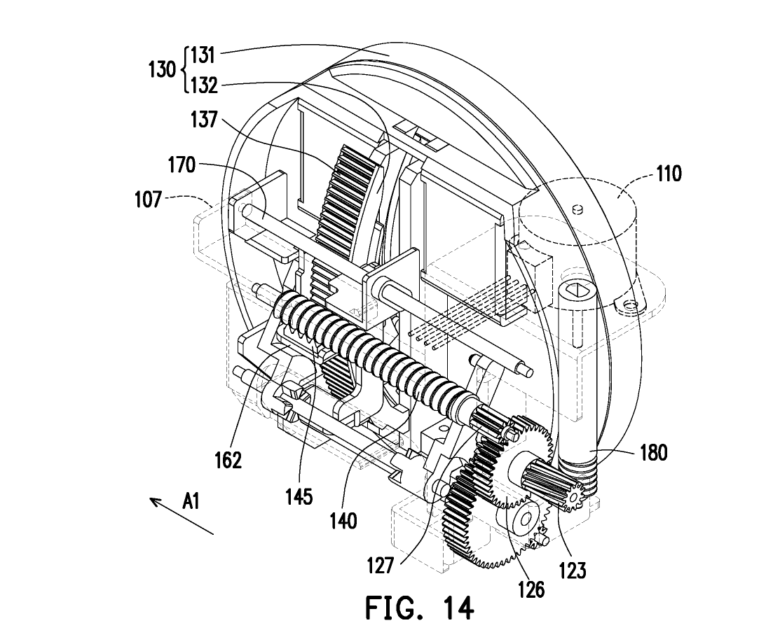

In the present embodiment, in addition to rotating downward from the first position P1 to the third position P3, the meter frame set 130 may also move horizontally from the first position P1 to the fourth position P4. FIG. 13 and FIG. 14 are respectively perspective schematic diagrams illustrating the meter frame set of the electronic device of FIG. 1 from different viewing angles without showing the housing when the meter frame set is located at the fourth position. Referring to FIG. 5, FIG. 13, and FIG. 14, in the present embodiment, the first screw rod 140 is linked with the gear set 120 and extends along the first axis A1. Specifically, the gear set 120 further includes a sixth gear 126 and a seventh gear 127. The sixth gear 126 is coaxial with and fixed to the third gear 123, the seventh gear 127 is coaxial with and fixed to the first screw rod 140, and the sixth gear 126 is engaged with the seventh gear 127. Accordingly, the motor 110 can drive the second screw rod 180 to rotate, the second screw rod 180 drives the third gear 123 and the sixth gear 126, and the sixth gear 126 drives the seventh gear 127 and the first screw rod 140. Therefore, when the motor 110 rotates, the first screw rod 140 can also rotate.

In the present embodiment, the second gear rack 145 extends along the first axis A1 and is adapted to be linked with the meter frame set 130. Specifically, the second gear rack 145 is disposed on the bracket 162 of the moving bracket set 160 and may move with the bracket 162 of the moving bracket set 160. When the meter frame set 130 is located at the first position P1, the moving bracket set 160 is linked with the meter frame set 130. Therefore, when the meter frame set 130 is located at the first position P1, the second gear rack 145 is linked with the meter frame set 130. As shown in FIG. 6, when the meter frame set 130 is located at the first position P1, the second gear rack 145 on the bracket 162 of the moving bracket set 160 is engaged with the first screw rod 140. When the motor 110 is operated and the second gear rack 145 is engaged with the first screw rod 140, the meter frame set 130 moves along the first axis A1 with the second gear rack 145 to the position as shown in FIG. 14.

In the present embodiment, the motion of the meter frame set 130 includes two directions and modes, i.e., upward/downward rotation and leftward/rightward movement. The motion of upward/downward rotation is accomplished mainly through coordination between the first gear rack 137 and the first gear 121 of the gear set 120. The motion of leftward/rightward movement is accomplished mainly through coordination between the first screw rod 140 and the second gear rack 145. In the present embodiment, the electronic device 100 drives the gear set 120 and the first screw rod 140 through one single motor 110 to enable the meter frame set 130 to rotate upward/downward and move leftward/rightward, which saves the costs of the electronic device 100. Moreover, since it is possible not to dispose a plurality of motors 110, the electronic device 100 may be miniaturized to save space.

In summary of the above, the meter frame set of the electronic device of one embodiment of the invention is engaged with the first gear through the first gear rack and can move along the arc line. Moreover, the meter frame set is further engaged with the first screw rod through the second gear rack and can move along the first axis with the second gear rack to meet different requirements of use.

Although the invention is disclosed as the embodiments above, the embodiments are not meant to limit the invention. Any person skilled in the art may make slight modifications and variations without departing from the spirit and scope of the invention. Therefore, the protection scope of the invention shall be defined by the claims attached below.

What is claimed is:

1. An electronic device comprising:
a motor;
a gear set, driven by the motor and comprising a first gear;
a meter frame set, comprising a first gear rack extending along an arc line, wherein the first gear rack is adapted to be engaged with the first gear of the gear set, and when the motor is operated and the first gear rack is engaged with the first gear, the first gear drives the first gear rack such that the meter frame set moves along the arc line;
a first screw rod, linked with the gear set and extending along a first axis; and
a second gear rack, adapted to be linked with the meter frame set, wherein when the motor is operated and the second gear rack is engaged with the first screw rod, the first gear rack is not engaged with the first gear, the meter frame set is linked with the second gear rack to move along the first axis with the second gear rack.

2. The electronic device according to claim 1, further comprising:
a moving lever, comprising a first bump, wherein the gear set comprises a second gear engaged with the first gear, the second gear comprises a first track recessed in one surface of the second gear, the first bump reaches into the first track, the first track comprises a first portion and a second portion, a first end of the first portion is connected to the second portion, a distance between a second end of the first portion and a gear center of the second gear is greater than a distance between the first end of the first portion and the gear center of the second gear, and the second portion is in an arc shape.

3. The electronic device according to claim 2, wherein the moving lever further comprises a second bump, the meter frame set comprises an arc-shaped member, the first gear rack is formed on the arc-shaped member, the arc-shaped member comprises a second track recessed in one surface of the arc-shaped member, the second bump reaches into the second track, the second track comprises a third portion and a fourth portion extending in different directions, and a third end of the third portion is connected to the fourth portion.

4. The electronic device according to claim 3, wherein when the meter frame set is located at a first position, the first gear of the gear set is located by the first gear rack and is not engaged with the first gear rack, the first bump is located at the second end of the first portion of the first track, and the second bump is located at the fourth end of the third portion of the second track, wherein when the second gear rotates such that the first bump of the moving lever moves to the first end of the first portion and the second bump of the moving lever correspondingly moves to the third end of the third portion, the first gear rack is pulled to the first gear, and the first gear rack is engaged with the first gear, such that the meter frame set moves from the first position to a second position.

5. The electronic device according to claim 4, wherein the fourth portion of the second track extends along the arc line to an end of the arc-shaped member, and when the meter frame set moves from the second position to a third position, the first bump of the moving lever moves along the second portion of the first track, and the second bump of the moving lever moves along the fourth portion of the second track and slides out of the arc-shaped member.

6. The electronic device according to claim 4, further comprising:
a moving bracket set, comprising a first through-hole, wherein a shape of the first through-hole is identical to a shape of the third portion of the second track, the second bump of the moving lever penetrates through the first through-hole and then reaches into the second track, and when the meter frame set moves between the first position and the second position, the meter frame set is linked with the moving bracket set.

7. The electronic device according to claim 6, further comprising:
a fixed horizontal shaft, extending along the first axis, wherein the moving bracket set comprises a second through-hole extending along a second axis, the fixed horizontal shaft penetrates through the second through-hole, and when the meter frame set moves between the first position and the second position, the meter frame set moves along the second axis with the moving bracket set.

8. The electronic device according to claim 6, wherein the second gear rack is disposed on the moving bracket set, wherein when the meter frame set is located at the first position, the second gear rack is engaged with the first screw rod, and when the meter frame set is located at the second position, the second gear rack is not engaged with the first screw rod.

9. The electronic device according to claim 1, further comprising:
a second screw rod, linked with the motor, wherein the gear set further comprises a second gear, a third gear, a fourth gear, and a fifth gear, the third gear is coaxial with and fixed to the fourth gear, the fifth gear is coaxial with and fixed to the first gear, the second screw rod is engaged with the third gear, the fourth gear is engaged with the second gear, and the second gear is engaged with the fifth gear.

10. The electronic device according to claim 9, wherein the gear set further comprises a sixth gear and a seventh gear, the sixth gear is coaxial with and fixed to the third gear, the seventh gear is coaxial with and fixed to the first screw rod, and the sixth gear is engaged with the seventh gear.
